(19) United States
(12) Patent Application Publication
(10) Pub. No.: US 2025/0205818 A1
(43) Pub. Date: Jun. 26, 2025

(54) LASER WELDING SYSTEM FOR WELDING A BUSBAR TO A STACK OF BATTERY CELLS, AND METHOD USING SAME

(71) Applicant: LASERAX INC., Québec (CA)

(72) Inventors: Stéphane MELANCON, Québec (CA); Alex FRASER, St-Michel-de-Bellechasse (CA); Geoffrey SAWYER, Québec (CA); Jean-Michaël DESCHENES, Lévis (CA)

(21) Appl. No.: 18/853,584

(22) PCT Filed: Apr. 11, 2023
(86) PCT No.: PCT/CA2023/050492

§ 371 Date: Oct. 2, 2024

Related U.S. Application Data
(60) Provisional application No. 63/329,647, filed on Apr. 11, 2022.
(60) Provisional application No. 63/401,305, filed on Aug. 26, 2022.

(51) Int. Cl. B23K 26/21; B23K 26/035; B23K 26/082; B23K 101/42; H01M 50/505; H01M 50/516

(52) U.S. Cl. CPC B23K 26/21; B23K 26/035; B23K 26/082; H01M 50/505; H01M 50/516; B23K 2101/42

(57) ABSTRACT

The laser welding system can have: a laser welder having an emitter configured to emit the laser beam, and a scanning head optically coupled to the laser emitter; a robot having an end effector having a body, a resilient member having a first end mounted to the body and a second end opposite the first end, a pressing element at the second end of the resilient member, and a laser aperture extending across the body, the resilient member and the pressing element; and wherein the laser beam can be directed across the laser aperture by the scanning head when either one of the pole regions is pressed against a corresponding one of the electrical poles by the pressing element.

### FIELD

The improvements generally relate to energy storing systems and more specifically to the assembly of a battery module.

### BACKGROUND

Typically, energy storing systems include one or more packs of multiple battery modules, with each battery module containing a number of battery cells held in an arrayed configuration relative one another (i.e., stacked), and a busbar connecting the battery cells in an electrical circuit. Among the existing various types of battery cells used in battery modules, cylindrical geometries are perhaps the most widely used. In some markets, such as electrical vehicles for instance, a widely used format has cylindrical geometries with both the positive pole and the negative pole accessible at the same end, which can be referred to as the pole end. Such as shown in the example presented in FIGS. 1, 1A and 1B, the battery cells can be stacked with the axes of the battery cells parallel to one another, the pole ends all facing the same side, and the pole ends are aligned within a common pole plane extending normal to the axes.

A component typically referred to as a busbar can be used to connect the battery cells, and more specifically the battery poles, in the electrical circuit. The busbar can be provided in the form of a sheet-like element having independent conductive paths with positive and negative pole regions. The busbar can be aligned parallel to the common pole plane and positioned adjacent the poles of the battery cells, with the pole regions of the busbar welded to corresponding ones of the poles.

The busbar and the battery cells are manufactured individually from one another and assembled to one another by a welding step. The welding step involves as many independent welds as there are pole regions and poles to be welded. Moreover, the battery cells are typically at least partially charged during the welding operation, since for many battery types, leaving a battery uncharged for extended periods of time may render it inoperable. Henceforth, the welding operation may involve positioning the stacked battery cells in a welding area of a welding system, with the poles facing upwardly and the busbar extending above the poles, with the pole regions vertically aligned with corresponding ones of the poles, and welding pole/pole region pairs to one another one by one until all the poles are welded to corresponding pole regions of the busbar, into a battery module configuration.

Although existing welding techniques were satisfactory to a certain degree, there always remained room for improvement.

### SUMMARY

In the context of migrating an increasing portion of energy consumption from fossil fuel energy towards electrical energy, manufacturing energy storing systems as efficiently as possible is desirable, which can involve different aspects.

For instance, some standardized battery cell formats, such as formats 21700 and 18650, for instance, are becoming more and more popular. Both these standardized formats have a generally cylindrical body, a protrusion located on the center of a first generally disk-shaped endface and forming a positive electric pole, and a negative electric pole embodied as an annular tip of a peripheral wall surrounding but radially separated from the positive pole, such as shown in FIGS. 1A and 1B, with the radial spacing being visible on FIG. 1A.

Welding pole regions of the busbar to poles of the battery cells using a laser can be particularly interesting from a point of view of precision and efficiency. However, it can be required to press the pole region against the corresponding pole prior to activating the laser beam for welding, to ensure that the pole region and pole have a good contact when heated by the laser. This raises the challenge of applying the pressure in a suitable way, i.e., in a relatively balanced way and sufficiently close to the region being welded, while not interfering with the path of the laser beam. Moreover, from a productivity standpoint, there can be a desire to perform all the welds in a manner which meets the specifications as fast as possible.

In accordance with one aspect, there is provided a laser welding system for welding pole regions of a busbar to electrical poles of a battery module with a laser beam when the busbar and battery module are received at a welding area with the pole regions located adjacent to and aligned with corresponding ones of the electrical poles, the laser welding system comprising: a laser welder having an emitter configured to emit the laser beam, and a scanning head optically coupled to the laser emitter; a robot having an end effector having a body, a resilient member having a first end mounted to the body and a second end opposite the first end, a pressing element at the second end of the resilient member, and a laser aperture extending across the body, the resilient member and the pressing element; wherein the laser beam is directed across the laser aperture by the scanning head when either one of the pole regions is pressed against a corresponding one of the electrical poles by the pressing element.

In particular, it can be advantageous for the resilient member to have a helical spring which has an axis parallel to the battery cell axis, and a pressing element having an annular body made of a thermally insulating material concentric with the helical spring, and held at the second end of the helical spring, and wherein the aperture forming the laser beam path extends along the axis of the helical spring and of the annular body.

In another aspect, it can be advantageous for the end effector to have two pressing elements, with each pressing element being resiliently supported on the body and having a corresponding aperture. The first pressing element can be a positive pressing element and the second pressing element can be a negative pressing element for instance. Indeed, moving the end effector of the robot takes time which is directly proportional to the speed of the robot, and the speed of the robot is typically slower than the speed at which the scanning head of the laser welder can move the orientation of the laser. By using a configuration where the end effector has two pressing elements and laser welding apertures, two welds can be performed, e.g., in sequence via an intermediary movement by the scanning head, without having to release the pressure or move the end effector, the end effector being only moved between pairs of welds. This can lead to a time saving and a corresponding increase in productivity.

In a particular case, the two pressing elements can each be supported independently from the other, via a corresponding resilient member, in a manner to allow the pressing elements to smoothly and naturally adapt to small variations which can occur in the exact height of the positive and negative pole regions from one battery cell to the next or from one battery module to a next one, such as by a negative pole being more or less flat from one battery cell to another.

Such a pressure-and-weld technique can be applied serially to all the pole regions of the busbar, until all of the pole regions are solidly welded to corresponding electrical poles of the battery module.

Indeed, such weld lines can be performed by laser welding. Laser-welding can provide weld lines which are clean and resistant at a relatively fast pace. In one embodiment, the laser-welding system has a housing enclosing a laser beam unit directed to a respective pole region. To perform the pressure-and-weld technique, the housing is moved against a pole region of the busbar, to which it applies pressure, while the laser beam unit enclosed within the housing is operated to laser weld the pole region to the underlying electrical pole. In such an embodiment, the collective weight of the housing and enclosed laser beam unit represents a source of inertia restraining the movement speed from one battery cell to another. In another embodiment, the laser beam unit can remain fixed but includes an optics system configured to change the orientation of the laser beam, for moving the laser beam from one pole region to another, while an independent, potentially lighter, pressing device performs the pushing action, potentially improving the assembly time.

In accordance with another embodiment of the present disclosure, there is provided a system for laser-welding a busbar atop a battery module, the busbar having at least a pair of pole regions positioned over a corresponding pair of electrical poles of the battery module, the system comprising: a laser-welding system having a scanning head with a field of view encompassing at least a portion of the busbar; and a robot arm having a first end fixed to a base and a second end movable within the field of view of the scanning head and being independent therefrom, the second end having an end effector having a body with a first face facing the scanning head, and an opposite, second face facing the busbar, and a laser aperture extending across the body from the first face to the second face, the second face having a plurality of pressure points surrounding the laser aperture; wherein, upon moving the end effector within the field of view of the scanning head to expose the pair of pole regions of the busbar to the scanning head through the laser aperture, said moving including forcing at least some of the plurality of pressure points of the end effector against the busbar and around the pole regions of the pair, the laser-welding system is activated for laser-welding each of the pole regions of the busbar to a respective one of the electrical poles of the battery module through the laser aperture.

In accordance with another embodiment of the present disclosure, there is provided a method for laser-welding a busbar atop a battery module, the busbar having at least a pair of pole regions positioned over a corresponding pair of electrical poles of the battery module, the method comprising: directing a field of view of a laser scanning head towards at least a portion of the busbar; moving an end effector within the field of view of the scanning head, the end effector having a body with a laser aperture extending across the body, the second face having a plurality of pressure points surrounding the laser aperture, said moving including exposing the pair of pole regions of the busbar to the laser scanning head through the laser aperture and forcing at least some of the plurality of pressure points of the end effector against the busbar and around the pole regions of the pair; and during said forcing, activating the laser scanning head to laser weld each of the pole regions of the busbar to a respective one of the electrical poles of the battery module through the laser aperture of the end effector.

In accordance with another embodiment of the present disclosure, there is provided an end effector for applying pressure atop a busbar having at least a pair of pole regions spaced apart from one another by a given distance, the end effector comprising a body with a first face, and an opposite, second face facing the busbar, and first and second laser apertures extending across the body from the first face to the second face, the first and second laser apertures being spaced apart from one another by the given distance and having dimensions being smaller than dimensions of the pole regions of the busbar, the second face having a plurality of pressure points surrounding each of the first and second laser apertures, the body having a robot arm anchor for attachment to a robot arm.

Many further features and combinations thereof concerning the present improvements will appear to those skilled in the art following a reading of the instant disclosure.

### DESCRIPTION OF THE FIGURES

In the figures,

FIG. 1 is an oblique view of an example of a busbar, in accordance with the prior art;

FIG. 1A is a sectional view of the busbar of FIG. 1, taken along section 1A-1A, showing an underlying battery module, in accordance with the prior art;

FIG. 1B is a top view of a portion of the busbar of FIG. 1, showing the underlying battery module and weld lines, in accordance with the prior art;

FIG. 2 is a schematic view of an example of a system for laser-welding a busbar to a battery module, shown with a laser-welding system and a robot arm having an end effector, in accordance with one or more embodiments;

FIG. 3 is a side view of the end effector of FIG. 2, in accordance with one or more embodiments;

FIG. 3A is a partial top view of the end effector of FIG. 2, in accordance with one or more embodiments;

FIG. 4 is a graph showing states for the laser-welding system and robot arm of FIG. 2 during two consecutive welding sequences, in accordance with one or more embodiments;

FIG. 5A is an oblique view of another example of an end effector, shown from above, in accordance with one or more embodiments;

FIGS. 5B and 5C are oblique views of the end effector of FIG. 5A, shown from below, in accordance with one or more embodiments;

FIG. 6 is a top view of another example of a system for laser-welding a busbar to a battery module, shown with multiple independent robot arms having respective end effectors moving within a field of view of a single laser-welding system, in accordance with one or more embodiments;

FIG. 7 is a graph showing states for the laser-welding system and the robot arms of the system of FIG. 6 during consecutive welding sequences, in accordance with one or more embodiments;

FIGS. 8A, 8B and 8C present another example embodiment of an end effector configured for acting as an end effector, in accordance with one or more embodiments;

FIGS. 9A and 9B present an alternate embodiment to a portion of the end effector of FIGS. 8A, 8B and 8C, in accordance with one or more embodiments;

FIGS. 10A and 10B to 16A and 16B present various alternate embodiments of end effectors adapted to an end effector such as shown in FIGS. 8A, 8B and 8C, in accordance with one or more embodiments;

FIG. 17 is an example of a flow chart of a method for laser-welding a busbar to a battery module, in accordance with one or more embodiments; and

FIG. 18 is a schematic view of an example of a computing device of a controller of a system for laser-welding a busbar to a battery module, in accordance with one or more embodiments.

### DETAILED DESCRIPTION

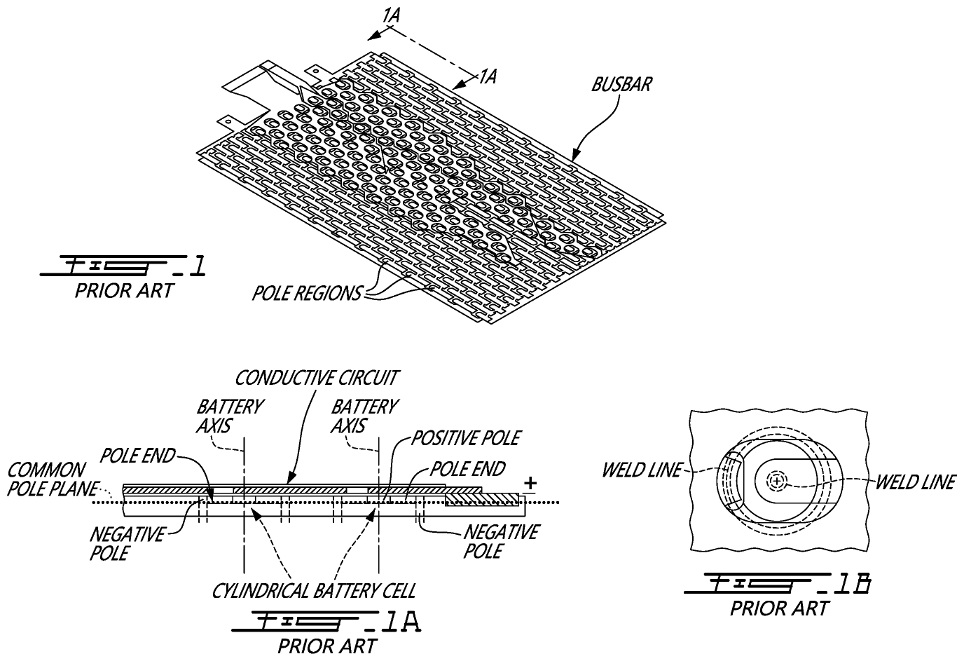

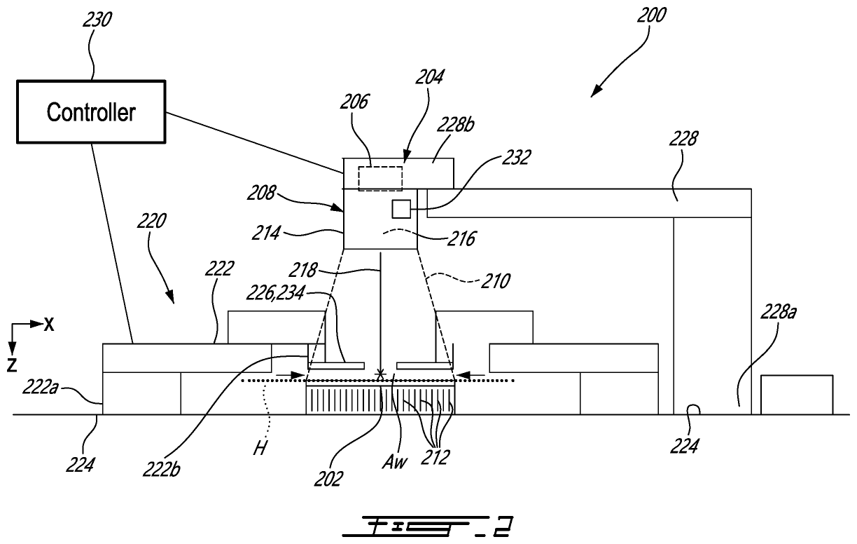

FIGS. 1 and 1A show an example of an energy storing device having a busbar which is to be welded to battery cells to form a battery module. In this example, the busbar is provided in the form of a sheet-like element having sets of pole regions interconnected via conductive paths. Typically, such a busbar can have a plurality of negative pole regions interconnected to one another via a negative conductive path, and a plurality of positive pole regions interconnected to one another via a positive conductive path, for example. The busbar can be deposited onto the arrayed battery cells in a manner aligning all the pole regions of the busbar to corresponding electrical poles of the battery cells (see FIG. 1A). The battery module includes a number of battery cells which are, in this example, of cylindrical shape. As depicted, the battery cells have both electrical poles accessible at a same, upper end. More specifically, each battery cell has an upper end with a first electric pole, which is provided here in the form of a protrusion located on the centre of one of the disk-shaped endface of the cell, and a second electric pole, provided here as an end of a peripheral wall extending between a first, upper end of the battery cell to an opposite second, lower end. In this example, the first electric pole is a positive pole, and the second electric pole is a negative pole. As shown, the busbar has at least a pair of positive and negative pole regions positioned over a corresponding pair of electrical poles of the battery module when the busbar is suitably positioned over the battery module. The poles can be reversed, and their respective shape, form or size changed depending on the embodiment. The battery cells showed in this example are standardized battery cell “size 21700,” however any other battery cell type can be used in other embodiments such as standardized battery cell “size 18650” to name another example. FIG. 1B shows a top view of the busbar showing the underlying battery cell in dashed lines. As shown, exemplary first and second weld lines for the positive and negative poles are also shown in dashed lines.

FIG. 2 shows an example of a laser welding system 200 for laser-welding a busbar 202. As shown, the laser welding system 200 has a laser welder 204 having a laser emitter 206 optically coupled to scanning head 208 with a field of view 210 encompassing at least a portion of the welding area A_{W}. In this example, the busbar 202 is aligned with a horizontal plane H. The scanning head 208 is positioned directly over the busbar 202 and oriented downwardly towards the busbar 202. However, while positioning the scanning head 208 above the busbar 202 can be preferred in some embodiments, in other embodiments the field of view 210 may be oriented obliquely relative to the busbar 202. The field of view 210 of the scanning head 208 encompasses a significant number of battery cells 212 such as more than twenty-five battery cells or more than one hundred battery cells. The scanning head 208 can include an enclosure 214 and a beam delivery output 216 positioned within the enclosure 214 and delivering a laser beam 218 when desired. Adjustable mirror assemblies can be included the scanning head 208 to receive the laser beam 218 and move it anywhere within the plane of the busbar 202, i.e., along the x- and y-axes. In some embodiments, the scanning head 208 can have an adjustable focal lens allowing a focal point of the laser beam to be moved along the z-axis. For instance, the adjustable mirror assemblies can include one or more 1-, 2- or 3-axes mirror galvanometer scanning heads and/or any other suitable optical component. As a result, the construction of the scanning head 208 can differ from one embodiment to another. In this embodiment, the busbar 202 is positioned within the field of view 210 of the scanning head 208 and at a distance within a working distance of the scanning head 208. Accordingly, the scanning head 208 needs not to be moved to laser-weld different portions of the busbar 202, the laser beam 218 is moved simply by the movement of the mirrors within the scanning head 208. The working distance of the scanning head 208 can range between 10 and 100 cm, between 25 and 75 cm or around 55 cm for example.

The laser welding system 200 has a robot 220 having first robot arm 222 having a first end 222a fixed to a base 224 and a second end 222b bearing the end effector 226 and movable within the field of view 210 of the scanning head 208. The base 224 can be a table or the ground of a manufacturing facility, depending on the embodiment. The first robot arm 222 can be any suitable type of manufacturing or industrial robot arm such as a delta robot arm, a SCARA robot arm, and the like. As shown, the first robot arm 222 can be operated independently of the operation of the scanning head 208, and can be moved independently of the activation or movement of the laser beam 218. Accordingly, the first robot arm 222 can be moved within the field of view 210 of the scanning head 208 as desired. In some embodiments, the laser welding system 200 can be provided with a second robot arm 228 having a first end 228a fixed to the same base 224 or a different base, and a second end 228b holding the scanning head 208 for movement thereof. As shown, the scanning head 208 can be moved in a plane parallel to the plane of the busbar 202 independently from the second end 222b of the first robot arm 222 as the first and second robot arms 222 and 228 are independent from one another. In other embodiments, the second robot arm 228 can be substituted for a gantry system having a holder holding the scanning head 208 and moving the scanning head 208 into the x-y plane, above the stack of battery cells 212.

The laser welding system 200 can include a controller 230 communicatively coupled to the laser-welding system 200, the first robot arm 222, the second robot arm 228, or a combination thereof. The controller 230 generally has a processor and a memory having stored thereon instructions that when executed perform steps of performing one or more laser-welding sequences including, but not limited to, i) moving the first and second robot arms 222 and 228 in a coordinated sequence of movement, ii) changing the orientation of the laser beam 218 using the scanning head 208, and iii) activating and deactivating the laser welder 204 when necessary. In some embodiments, the laser welding system 200 can have a camera 232 communicatively coupled to the controller 230. The camera 232 can be configured for acquiring one or more two- or three-dimensional images of the busbar 202. The controller 230 can then receive the image(s) and determine a position and an orientation for each one of the pair(s) of pole regions of the busbar 202 which can then be used for laser-welding sequence. In some embodiments, the position and orientation of the pole regions of the busbar 202 is determined at a modeling station spaced apart from the laser-welding station. For instance, a three-dimensional model of the battery module and its busbar can be made at the modeling station. In these embodiments, the camera 232 can be used to detect the position of one or more fiducials on the battery module(s) which can help the positioning of the three-dimensional model within a coordinate system of the laser welding system 200.

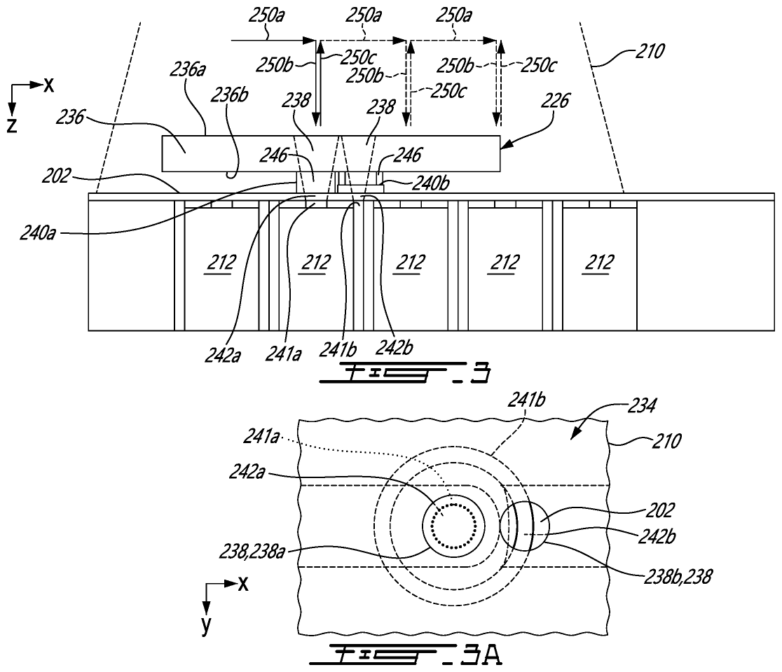

In this embodiment, the end effector(s) 226 of the robot 220 can be embodied as a pressure applicator 234. In this embodiment, as best shown in FIG. 3, the end effector 226 has a body 236 with a first face 236a facing the scanning head, and an opposite, second face 236b facing the busbar 202. The body 236 of the end effector 226 also has one or more openings forming at least one laser aperture 238 extending across the body 236 from the first face 236a to the second face 236b. The end effector 226 can have one or more portions configured for being in contact with the busbar 202 during application of the pressure to the pole regions, and such portions can be referred to as “pressing elements 240”. Each pressing element 240a, 240b typically has a certain surface area which is configured to partially or fully surround the pole regions, with a view of balancing out the pressure, and can thus be said to have a plurality of pressure points surrounding the laser aperture 238. The end effector 226 can have a weight below 5000 grams, preferably below 1000 grams and more preferably below 500 grams. By limiting the weight of the end effector 226, its resistance to movement or inertia is limited which can in turn allow faster end effector displacements. The end effector 226 can be moved by the second end of the first robot arm at a maximal speed of at least 5 m/s, preferably at least 8 m/s and more preferably at least 12 m/s. In some embodiments, the time required for an instance of the laser-welding sequence is below 500 ms, preferably below 300 ms and more preferably below 200 ms, for example.

In an embodiment where the positive and negative poles 241a and 241b of the battery cells 212 are both accessible on the same face of the battery array, it can be convenient for the end effector 226 to have both a positive, first pressing element 240a and a negative, second pressing element 240b, each having an associated laser aperture 238, through which a corresponding one of the positive pole region 242a and or the negative pole region 242b of the busbar 202 can be welded sequentially (i.e., without moving the end effector 226 therebetween), or simultaneously (i.e., if there is more than one laser beam).

In some embodiments, it can be preferred for a pressing element to be received by the body 236 of the end effector 226 via a resilient member 246, as this can allow some greater flexibility to adapt to relatively minor variations in height from one pole region to the next, for instance, and to facilitate the application of a generally uniform pressure from one pole region to the next along the welding path. Moreover, in some embodiments, it can be preferred for a pressing element to be a distinct component assembled to the resilient member, as opposed to being embodied simply as a portion of the pressing element. This can allow the pressing element and the resilient member to be made of different materials, for instance, or simply to be manufactured separately.

It will be noted that in some embodiments, a minimal charge may be required to remain in the battery cells at all time, in order to preserve the functionality of the battery cells. Accordingly, electrical energy may reside in the battery cells during the welding operation. In some embodiments, and especially in embodiments where a positive pressing element 240a and a negative pressing element 240b are both included in the end effector 226, it can be desired to electrically insulate the end effector 226 generally, or one or both positive and negative pressing elements 240a and 240b, from the remainder of the mechanical assembly. It can be relevant, for instance, to electrically insulate the positive pressing element 240a from the negative pressing element 240b to avoid a short circuit therebetween. Accordingly, in one embodiment, it can be desired for either one, or preferably both of the pressing elements 240a and 240b, to be electrically insulating. In one embodiment, this may be achieved by making the pressing elements 240 out of a material which is inherently electrically insulating, such as a plastic, or a ceramic material for instance. In another embodiment, this may be achieved by coating an inherently electrically conductive material, such as a metal, with an electrically insulating coating. In the context of this specification, a material can be considered electrically conductive if it has a conductivity of more than 10² S/m, preferably more than 10⁵ S/m whereas a material can be considered electrically insulating if it has a conductivity below 10⁻³ S/m, preferably below 10⁻¹⁰ S/m.

Moreover, it will also be noted that in some embodiments, the laser activity can generate a significant amount of heat and therefore, it can be desired i) for one or more pressing elements 240a and 240b, and possibly also for one or more resilient members 246 to be thermally resistant, i.e., to be adapted to resist to the potentially high temperatures which can be expected during the laser welding process, and ii) for one or more pressing elements 240a and 240b to play a role of thermal insulation from the remainder of the mechanical assembly. Indeed, the pressing elements 240a and 240b can be relatively close to the area being subjected to welding, and thermally conductive metal of the busbar 202 may directly extend therebetween, leading to high temperatures at the pressing points. Accordingly, it can be desired for the pressing elements 240a and 240b to be not only made of an electrically insulating material, but further of a material which is thermally insulating, and potentially also resistant to relatively high temperatures. In some embodiments, a ceramic material or high temperature plastics can be particularly interesting in the circumstances. In the context of this specification, a material can be considered thermally conductive if it has a thermal conductivity of more than 1 W·m⁻¹·K⁻¹, preferably more than 100 1 W·m⁻¹·K⁻¹, and thermally insulating if it has a thermal conductivity of less than 1 W·m⁻¹·K⁻¹, preferably less than 0.1 W·m⁻¹·K⁻¹. In this specification, a material can be considered to be thermally resistant if it preserves its mechanical and structural properties at temperatures above 300° F., preferably above 500° F.

The welding process for assembling a battery module can consist of a series of welding sequences. An instance of the welding sequence, in one embodiment, generally includes a step of moving the end effector 226 within the field of view 210 of the scanning head to expose a positive and/or negative pole region 242a and 242b of the busbar 202 to the scanning head through the laser apertures 238, such as shown in FIG. 3A, and directing the laser beam orientation to the corresponding positive and/or negative pole regions 242a and 242b. When the end effector 226 has reached the corresponding pole region, it can be controlled to apply a force, e.g., via the pressing elements, to sandwich the pole regions of the busbar 202 against the positive and/or negative poles of a corresponding battery cell. While the end effector 226 is maintained in position, the laser-welding system is activated to laser weld the corresponding pole region of the busbar 202 to a corresponding electrical pole of the battery cell through the laser aperture 238. The laser-welding sequence can be repeated for a sequence of battery cells to result in first and second weld lines, one for each of the pair of positive and negative pole regions 242a and 242b of the busbar 202.

As shown in FIG. 3A, the laser aperture 238 can include first and second laser apertures 238a and 238b each sized and shaped to expose a corresponding one of the positive and negative pole regions 242a and 242b of the pair. For instance, the first laser aperture 238a is sized and shaped to expose the positive pole region 242a being above the positive pole 241a of the battery cell 212 whereas the second laser aperture 238b is sized and shaped to expose the negative pole region 242b being above the negative pole 241b of the battery cell 212. In some embodiments, it can be preferred for the second laser aperture 238b to conform better in shape to the shape of the negative pole 241b, such as being elongated and somewhat arc-shaped, for instance. Referring back to FIG. 3, it was found convenient in some embodiments to have the laser aperture, e.g., the first and/or second laser apertures 238a and 238b, with taper shapes decreasing in diameter from the first face 236a to the second face 236b of the end effector 226. In this way, the pole regions 242a and 242b of the busbar 202 can be exposed to the field of view 210 of the scanning head at greater angles. In some other embodiments, the body 236 of the end effector 226 has a thickness below a certain threshold, thereby allowing exposition at greater angles as well. For instance, in one embodiment, the body 236 of the end effector 226 can be flat and have a ranging between 1 and 20 mm, preferably between 2 and 10 mm and more preferably around 5 mm. In other embodiments, the body 236 can have different shapes.

As shown in FIG. 3, an instance of the welding sequence can include: a transversal movement 250a within a plane parallel to a plane of the busbar 202, via which the end effector 226 is moved into along the X-Y plane (e.g., horizontal) alignment with a given battery cell 212; a vertically downwards movement 250b, which can lead to the application of pressure; a period of immobility time during which the laser-welding is performed (the laser, directed to the corresponding region, is activated); and a vertically upwards movement 250c in which the end effector 226 is moved away from the busbar 202 after the laser-welding, including a relief of pressure. In an embodiment having more than one robot, the laser welder can alternate from one end effector to the other, with one end effector being displaced while welding is occurring at the other end effector.

In some embodiments, the pressing elements 240a and 240b of the end effector 226 protrude from the second face 236b of the end effector 226. The pressing elements 240a and 240b can form one or more perimeters surrounding either one or both the positive and negative pole regions 242a and 242b of the busbar 202 when the end effector 226 is into position. The pressing elements 240a and 240b may be biased against the second face 236b of the body 236 as well, thereby allowing to convey a tightly reproducible force from one battery cell to another. The biasing mechanism can take different forms depending on the embodiment, and can typically involve one or more resilient members. For instance, in the illustrated embodiment, the end effector 226 has a first coil spring having a first hollow end mounted to the second face and surrounding the first laser aperture and an opposite second hollow end spaced apart from the first hollow end. As shown, the second hollow end of the coil spring includes one or more pressing elements. In position, the second hollow end surrounds the positive pole region of the busbar and forces it against the underlying positive pole of the battery cell. The end effector also has second coil springs with first hollow ends mounted to the second face and distributed around the second laser aperture, and opposite second hollow ends spaced apart from the first hollow ends. As shown, the second hollows ends of the second coil springs include one or more pressing elements. As such, when the end effector is moved vertically downwards, the pressing elements can be biasingly engaged with the surroundings of the negative pole regions of the busbar. Other types of coils or biasing mechanisms can be used in other embodiments.

In some embodiments, the robot arm may be configured for moving the end effector 226 solely within a plane parallel to the busbar 202, whereas the second end of the robot arm can have a distinct actuator configured for moving the end effector 226 across the plane (i.e., along the Z-axis) of the busbar 202, whereas in other embodiments, the robot arm can be responsible for moving the end effector 226 freely in the three dimensions.

In some embodiments, the second end of the robot arm can have a distinct actuator configured for rotating the end effector 226 about an axis normal to the plane of the busbar 202 (i.e., around the Z-axis). Such a latter actuator can help ensuring that the first and second laser apertures 238a and 238b of the end effector 226 are aligned with corresponding pole regions 242a and 242b of the busbar 202, which can be relevant, for instance, when the robot arm has a member which pivots in the X/Y plane. In some embodiments, the actuator is rotatably mounted to the second end and/or to the end effector using a bearing having a centre laser aperture through which the laser beam can be directed.

In one embodiment, moving can further include rotating the end effector about an axis normal to the plane of the busbar to ensure the laser aperture suitably exposes the pair of positive and negative pole regions of the busbar across corresponding ones of the laser apertures. The rotating can be performed during the transversal movement 250a, during the vertically downwards movement 250b and 250c or sequentially after either one of the movement steps, depending on the embodiment.

FIG. 4 is a graph 400 showing two consecutive welding sequences 452 which can be performed by the system of FIG. 2. As shown, the first robot arm moves laterally during a first period of time t1, then moves vertically downwards for a second period of time t2, after which it is held into position for a third period of time t3. The laser-welding system is activated during the third period of time t3 to perform the required weld lines. The first robot arm is then moved vertically upwards for a fourth period of time t4. The welding sequence can be performed a number of times until all the pairs of positive and negative pole regions of the busbar are suitably welded to corresponding poles of the battery cells. In one example embodiment, the first, second and fourth periods of time t1, t2 and t4 each amounts for 60 ms while the third period of time t3 lasts only 20 ms, i.e., the time required for the laser-welding system to perform two weld lines, with the laser-welding system being activated only ˜11% of the whole time associated to a given instance of a welding sequence. In another embodiment, the first, second and fourth periods of time t1, t2 and t4 each amounts for 50 ms while the third period of time t3 lasts only 15 ms. As can be noted, in this example, the time of the whole welding sequence is strongly affected by the movement of the first robot arm, which suggests that reducing the footprint, and overall weight of the end effector can in turn favourably impact the total time of the welding sequence, for a given robot.

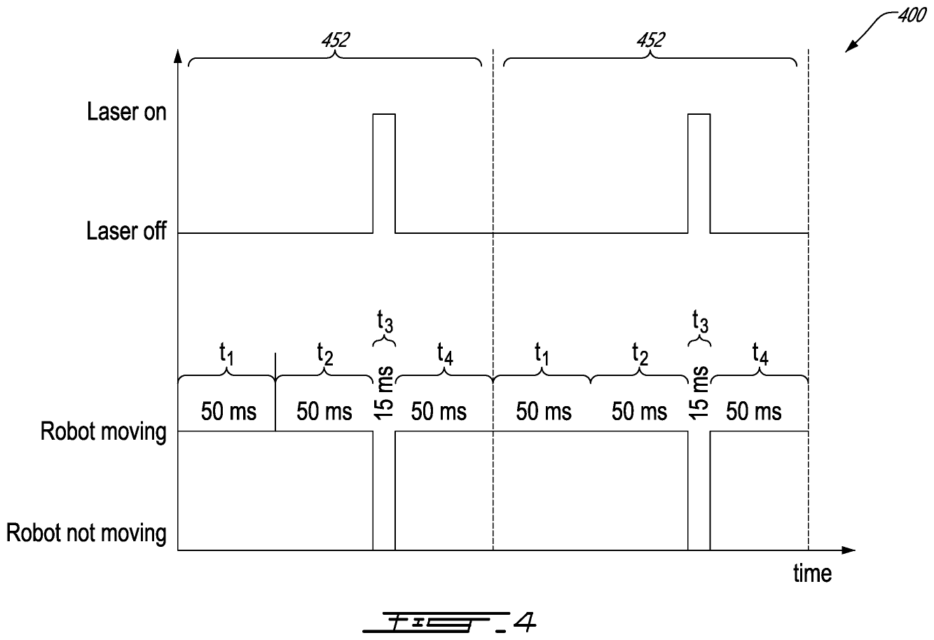

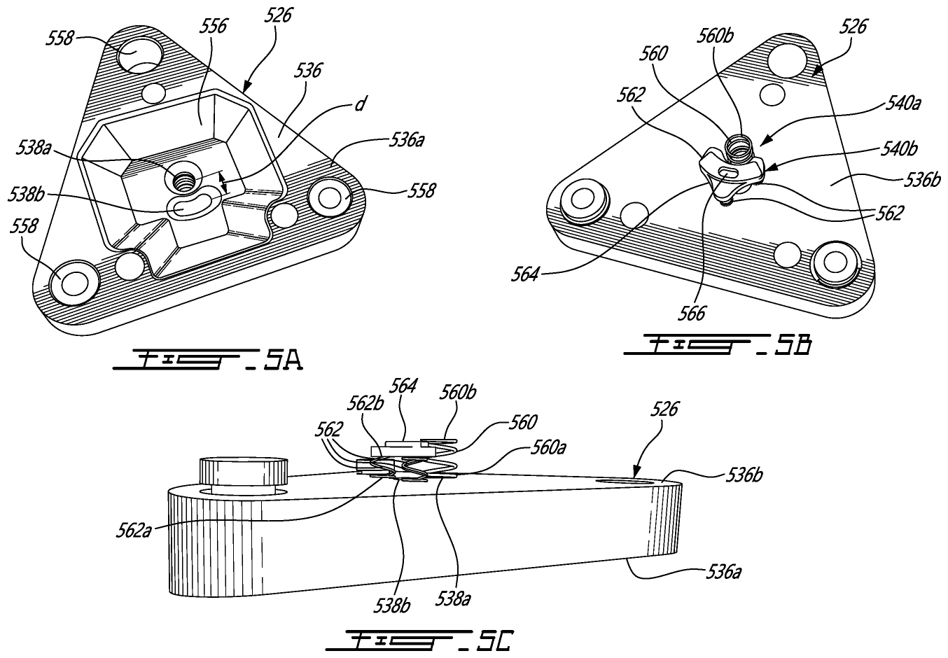

FIGS. 5A, 5B and 5C show an example of an end effector 526 for applying pressure to a busbar having positive and negative pole regions spaced apart from one another by a given distance. As shown, the end effector 526 has a body 536 with a first face 536a shown in FIG. 5A and a second face 536b opposite the first face 536a (shown in FIG. 5B). The body 536 has a flat, triangular-like shape in this example. As shown, the body 536 has first and second laser apertures 538a and 538b extending across the body 536 from the first face 536a to the second face 536b. The first and second laser apertures 538a and 538b are spaced apart from one another by a given distance d in this example. The first face 536a has a depression 556 inside which the first and second laser apertures 538a and 538b are formed. The body 536 has one or more robot arm anchor(s) 558 for attachment to the second end of the first robot arm. The robot arm anchors 558 are provided in the form of threaded cavities that can be removably or fixedly attached to the second end of the first robot arm using one or more bolts. In some embodiments, the first laser aperture 538a has a diameter which is smaller than a diameter of the positive pole region whereas the second laser aperture 538b has a dimension which is smaller, at least along a single axis or arc, than a corresponding dimension of the negative pole region of the busbar, adapted to allow the laser beam to form a weld line in a portion of the negative pole region and of the positive pole region.

Also shown in this embodiment, the first and second laser apertures 538a and 538b of the end effector 526 have a tapered shape decreasing in size from the first face 536a to the second face 536b. The first laser aperture 538a has a circular shape designed to encompass the pole region of the busbar which is just above the positive pole of the battery cell. The second laser aperture 538b has a curvilinear shape which is designed to encompass an arc of the negative pole region of the busbar which is just above a portion of the negative pole of the battery cell.

As best shown in FIGS. 5B and 5C, the second face 536b has first and second pressing elements 540a and 540b surrounding a respective one of the first and second laser apertures 538a and 538b. The first pressing element 540a has a first helical spring 560 having a first open end 560a mounted to the second face 536b and surrounding the first laser aperture and an opposite second open end 560b. In this embodiment, the first pressing element 540a is embodied as the circularly curved second open end 560b of the first helical spring 560. In this way, the laser-welding beam can be directed into and along the hollowness of the first coil spring 560 during laser-welding. The end effector 526 also has three second coil springs 562 having first open ends 562a mounted to the second face 536b and distributed around the second laser aperture 238b, and opposite second open ends 562b. In this example, the second pressing element 540b is provided in the form of a pressure plate 564 mounted at the second open ends 562b of the second coil springs 562 to provide an even distribution of pressure. The pressure plate 564 can offer one or more pressure points in this example. The pressure plate 564 has a laser aperture 566 comprised, in the horizontal orientation, within a perimeter defined by the three second springs 562. As shown, the aperture 566 is sized and shaped to expose an arc of the negative pole region of the busbar which is just above a portion of the negative pole of the battery cell.

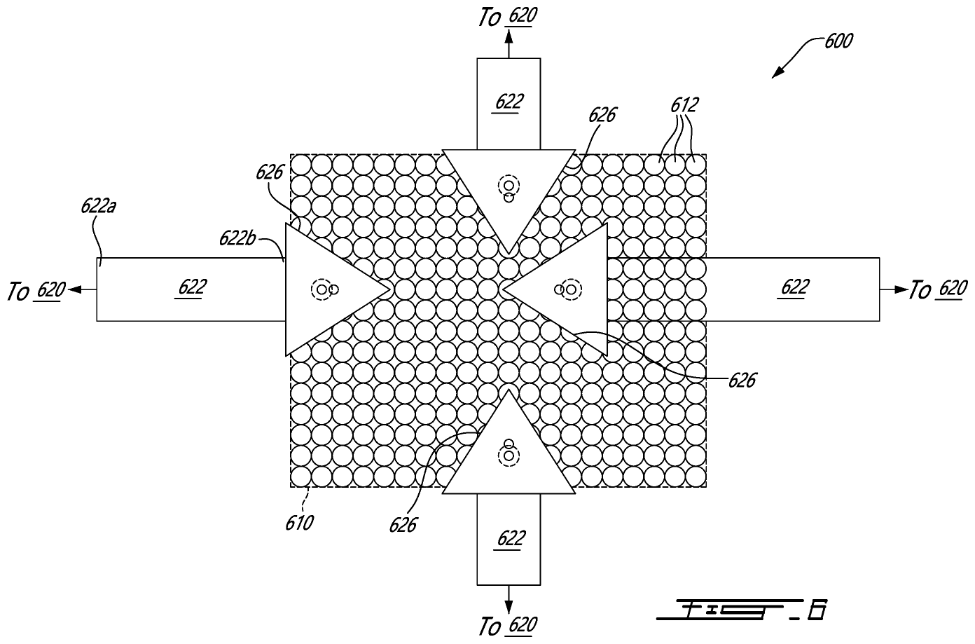

In some embodiments, more than one robot or robot arm can be provided. Referring now to FIG. 6, there is shown an example of a system 600 including four different and mechanically independent robots 620, each having a robot arm 622 with a dedicated end effector 626. As shown, the triangular-like shape of the end effectors 626 can provide at least some clearance thereby allowing greater movement possibilities for each of the end effectors 626. The four end effectors 626 are attached to the second ends of the robot arms 622 using a cantilevered member. The cantilevered members can help clearing the field of view of the scanning head from parts of the robot arms that could obstruct it. In this example, each of the robot arms 622 has its first end 622a fixed to a base located on a respective side of the battery module, with its second end 622b being movable above the pack of battery cells 612 within the field of view 610 of the laser-welding system. By using multiple robot arms 622, the time required to laser weld all of the pole regions of the busbar to corresponding electrical poles of the battery cells 612 can be significantly reduced. FIG. 7 shows a graph 700 showing the states of the laser-welding system and of the first robot arms states during consecutive welding sequences 752. As shown, each of the robot arms is performing a similar welding sequence 752 but delayed from one another. Accordingly, this can allow the laser-welding system to be activated four times as much during a single welding sequence, which can reduce the amount of time required to laser weld all the battery cells of a module. In some embodiments, only one first robot arm can be sufficient. In some other embodiments, two or more first robot arms can be used to proportionally optimize the laser-welding sequences and overall throughput.

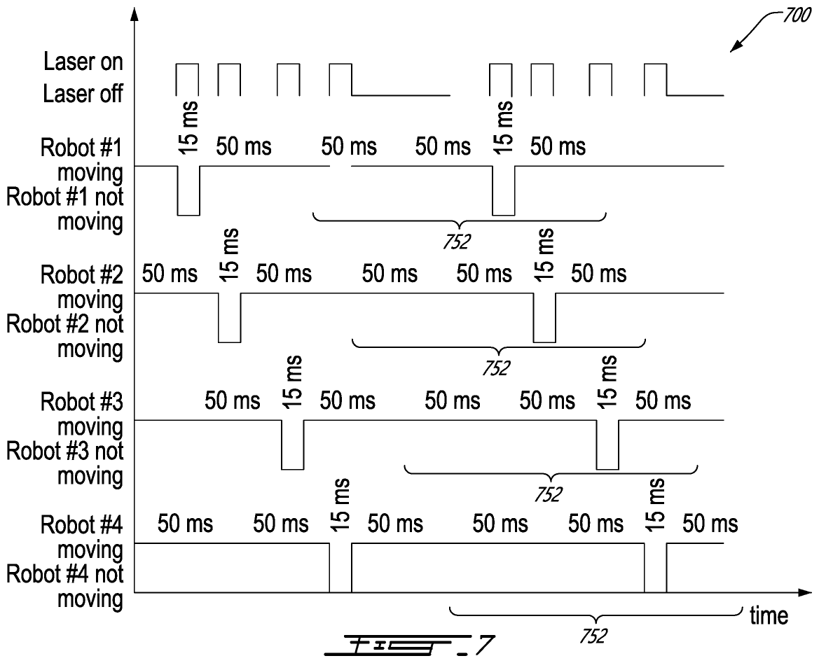

FIGS. 8A to 8C present yet another example embodiment of an end effector 826 adapted for the purpose of applying pressure between pole regions of a busbar and electrical poles of a stack of battery cells during the laser welding of corresponding pole regions to corresponding electrical poles. The end effector 826 is shown more generally in FIG. 8A as having a proximate end 826a bearing a robot arm anchor configured for securing the end effector 826 to the second end of a robot arm, and a distal end 826b opposite the proximal end 826a. As best shown in FIGS. 8A and 8B, the end effector 826 bears a body 836, a resilient member 860 having a first end mounted to the body 836 and a second end opposite the first end, and a pressing element 840a at the second end of the resilient member 860. A laser aperture 838a extends across the body 836, the resilient member 860, and the pressing element 840a. More specifically, in this embodiment, the pressing element 840a is a first pressing element 840a, and the end effector 826 further has a second pressing element 840b, although the presence of two pressing elements is optional. If present, either one of the first and second pressing elements 840a and 840b can act as a positive pressing element, and the second one can act as a negative pressing element.

In the embodiment presented in FIGS. 8A to 8C, the first pressing element 840a is annular in shape with an axis which can be oriented normal to the plane of the busbar by the robot during the laser activation. The resilient member 860 has a helical spring defining a helix around an axis coinciding here with the axis of the first pressing element annulus. The first pressing element 840a is provided as a distinct component from the resilient member 860 in this example, as it is mounted to the second end of the helical spring. The first pressing element 840a can be made of a thermally resistant material. The first pressing element 840a can be made of a thermally insulating material. The first pressing element 840a can be made of an electrically insulating material. Typically, but not always, a good thermal insulator material is also a good electrical insulator. A material such as a ceramic, a high temperature plastic or zirconium(IV) silicate can be convenient for use as the material of the first pressing element 840a. The use of a thermally insulating material can contribute to protect the helical spring 860 from the heat generated by the laser activation. The laser aperture 838a extends along the axis and through the laser aperture 838a formed by the annulus. Such a geometry can be particularly well adapted for the welding of a positive pole.

In the embodiment presented in FIGS. 8A to 8C, the second pressing element 840b is adjacent the first pressing element 840a. As shown, the first pressing element 840a and the second pressing element 840b are held at different distances from the body 836 when free from the busbar. Typically, such a height difference can result from embodiments where the positive electrical pole is slightly elevated relative to the negative electrical pole of the battery cell. The second pressing element 840b has a pressing body generally planar in shape and horizontally orientable by the robot arm, with a protrusion leading to a pressing tip 868 bearing the laser aperture 838b. The second pressing element 840b can be mounted to the end effector body by a resilient member in the form of a plurality of springs 862. The springs 862 can circumscribe the laser aperture 838b in a manner to balance out the load between them. In the illustrated embodiment, three springs 862 are used.

As best seen in FIG. 8B, the pressing tip 868 of the second pressing element 840b can somewhat be associated to the shape of a cashew in this embodiment, i.e., it has a generally obround shape (i.e., elongated with rounded ends) which is bent and curved along its length in a manner to follow the shape of an arc of the negative pole. It will be referred to as cashew-shaped in this specification for convenience. The second pressing element 840b can be made of a ceramic material, of a high temperature plastic material, or of a metal to name some examples. If a metal is chosen, it can be coated with an electrically insulating material if suitable. It will also be noted that the protruding of the pressing tip from the remainder of the pressing body may be useful in some embodiments to avoid “obstacles”, i.e., portions of the busbar and/or battery cell which could otherwise come into interference with the movement of the end effector 826.

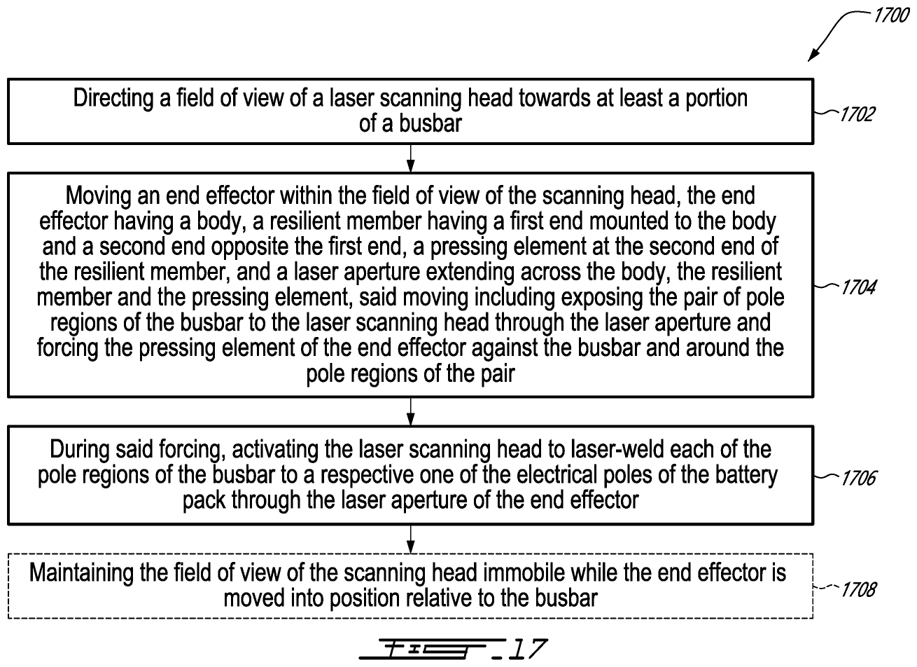

In the illustrated embodiment, the resilient member 862 supporting the second pressing element 840b is distinct from the resilient member 860 supporting the first pressing element 840a in this embodiment, which can provide additional versatility suitable to some embodiments, but this is optional. In some embodiments, the first and the second pressing elements 840a and 840b can have distinct laser apertures and/or pressing points while being supported by a same resilient member for instance, an example of which is described with reference to FIGS. 16A and 16B. The use of distinct resilient members can be useful, for instance, in allowing to better adapt to eventual variations in height difference (and/or thickness) between the positive and negative pole regions in a manner to facilitate the application of a uniform pressure from one pole pair to another pole pair.

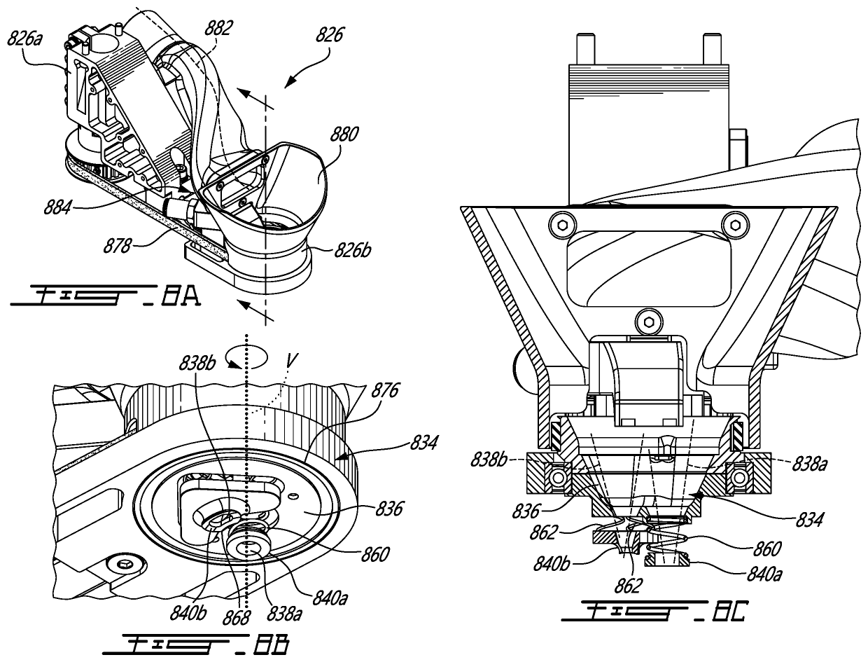

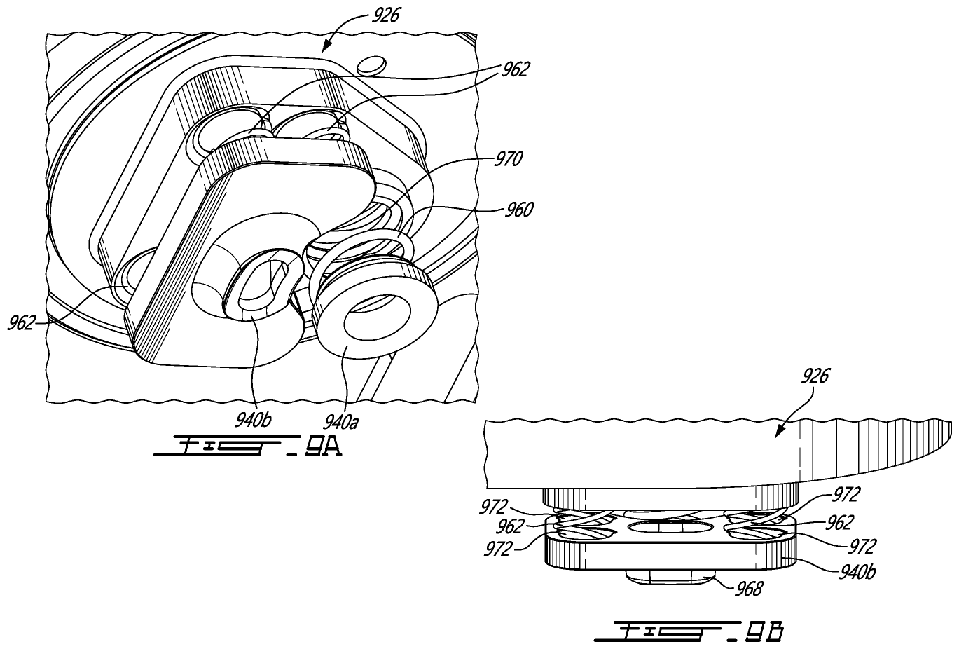

FIGS. 9A and 9B present an alternate embodiment of an end effector 926 which is generally similar to the embodiment portrayed in FIGS. 8A to 8C, but different in that the pressing body of the second pressing element 940b is generally rectangular in shape instead of generally triangular in shape, and is supported by four helical springs 962 instead of three. Moreover, the pressing body 940b has a lateral recess 970 configured to accommodate the relative displacement of the first, annular, pressing element 940a. Moreover, the body of the end effector 934 is generally cylindrical and flat in shape, but has a protuberance leading to helical spring seats 972. The protuberance can help clearing other portions of the robot and of its end effector from eventual obstacles formed by portions of the busbar, battery cells, or other portions of the battery module.

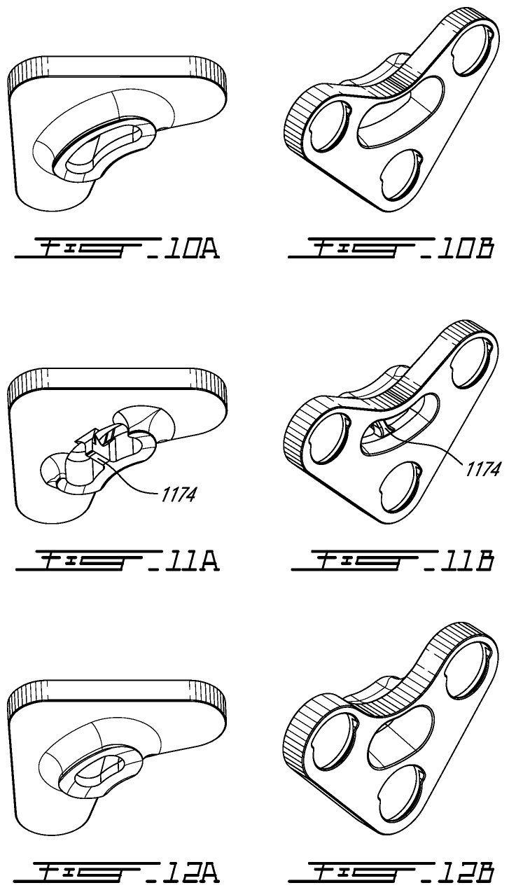

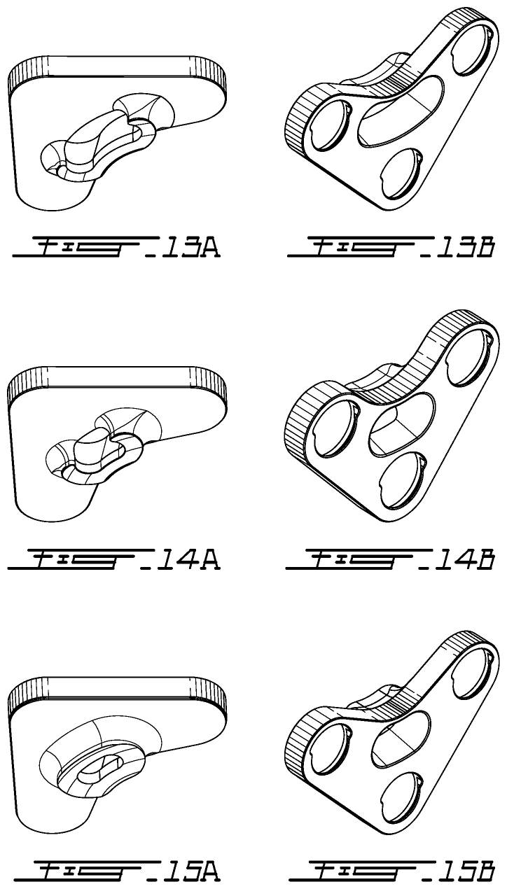

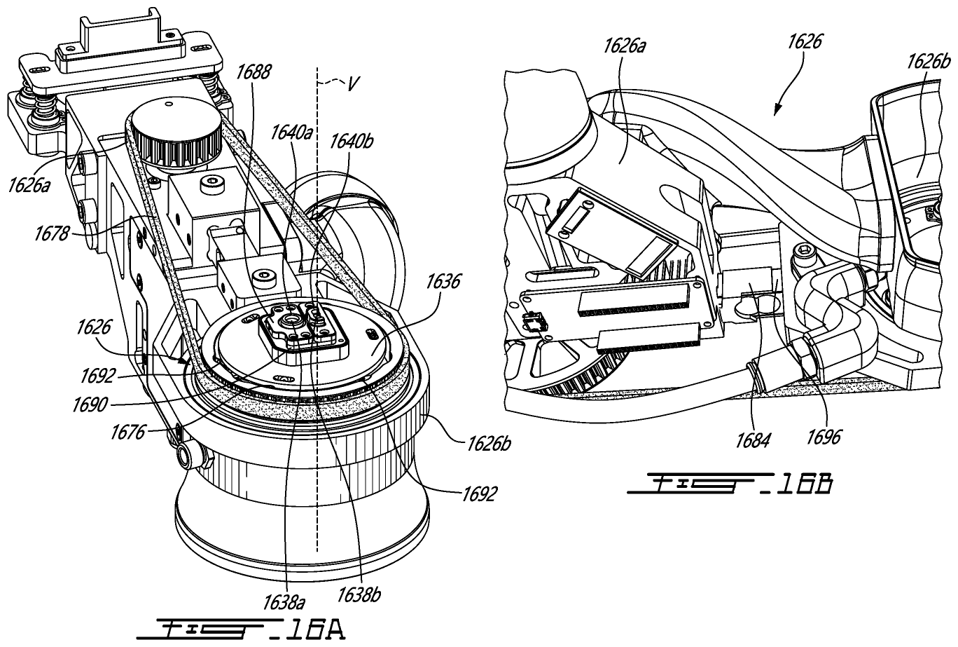

FIGS. 10A and 10B to 15A and 15B present many exemplary potential variants of a second pressing element. FIGS. 15A and 15B have an opening and a pressing tip extending along a shorter arc portion, for instance, than the embodiment shown in FIGS. 10A and 10B. FIGS. 12A and 12B having a radially broader opening than the embodiment shown in FIGS. 15A and 15B. In the case of FIGS. 11A, 11B, 13A, 13B, 14A, 14B, the pressing element forms an open shape as opposed to the closed-loop shapes shown in the other embodiments. Such an open shape may be useful to avoid an obstacle, which may be present on the radially outward side in some embodiments. In the example of FIG. 11A, a partition 1174 is present and can contribute to distributing the applied pressure differently. Other variations are possible.

Referring back to FIGS. 8A, 8B and 8C, it will be noted that the illustrated example end effector 826 has a number of additional optional features. In particular, the body 836 of the end effector 826 which supports the pressing elements 840a and 840b and resilient members 860 and 862 is disc-shaped and rotatably mounted in a circular opening 876, e.g., via ball bearings, in a manner to be rotatable around a vertical axis V normal to the busbar. Moreover, a motor, such as an air actuator for instance, is provided at the first end 826a of the end effector 826, connected to the body via a pulley 878. This mechanical arrangement is adapted to allow the robot to rotate the pressing elements 840a and 840b in a plane parallel to the busbar in a manner to facilitate the alignment of the pressing elements 840a and 840b with corresponding ones of the positive and negative regions of the busbar.

Moreover, the laser apertures 838a and 838b extend continuously, vertically upwardly, and lead into to an open-ended collector receptacle 880 of the end effector 826. As shown, the collector receptacle 880 extends away from the body 836, opposite the pressing elements 840a and 840b. As such, the collector receptacle 880 is in fluid communication with the laser aperture 838a and 838b. The collector receptacle 880 can have outwardly tapered walls allowing better clearance to oblique laser beam angles leading to the laser apertures. The collector receptacle 880 can delimit a gas path 882. An aspirator can be provided and have an aspiration mouth open to the collector receptacle 880. This arrangement can be useful to aspire, along an aspiration conduit, “sputter” formed of red-hot particles of metal which can be caused by the laser beam activation, more efficiently than if no collector receptacle was present to delimit the gas path. In some embodiments, it can further be desired to provide an inert gas conduit leading into the collector receptacle, for instance.

Another optional feature included in the embodiment presented in FIGS. 8A, 8B and 8C is a load cell 884 which can be provided along a structural member extending from the first end 826a of the end effector 826 to the second end 826b of the end effector 826. In some example, the structure member can be shaped as a cantilever. The load cell 884 can provide an indication of the amount of bending stress present in the end effector, as a means of determining the amount of pressure applied collectively by both pressing elements. The load cell can generate a load cell signal which can be fed back to the robot controller in a manner to achieve further precision or consistency in the application of pressure. The anchor at the first end 826a of the end effector 826 can be specifically adapted to be mounted to a SCARA SR-6ia robot in this example or to another robot as deemed relevant.

FIGS. 16A and 16B show another example of an end effector 1626. As depicted, the end effector 1626 has a body 1636 which receives first and second pressing elements 1640a and 1640b via a resilient member 1690. The resilient member 1690 can be made of any type of resilient material including, but not limited to, silicon rubber. The first pressing element 1640a is secured to the body 1636 via the resilient member 1690. The second pressing element 1640b is also secured to the body 1636 via the same resilient member 1690. As such, the resilient member 1690 has a first end mounted to the body 1636 and a second end mounted to the pressing elements 1640a and 1640b. The resilient member 1690 can have a sheet-like shape and can act as a mattress for the first and second pressing elements 1640a and 1640b. In this way, the portion of the resilient member 1690 receiving the first pressing element 1640a can be resiliently independent from the portion of the resilient member 1690 receiving the second pressing element 1640b. The resilient member 1690, which is resiliently connected to the first and second pressing elements 1640a and 1640b, can be compressed to snugly fit the pole regions of the busbar upon the end effector 1826 being pressed against the busbar. The resilient member 1690 can thus account for differences in height of the positive and negative pole regions of the busbar between adjacent battery cells. It is intended that the first and second pressing elements 1640a and 1640b are removably mounted to the resilient member 1690 which is itself removably mounted to the body 1636. In this way, these components are consumables which can be replaced when damaged or after a given working hour threshold has been met. In some embodiments, the body 1636 has a removable portion to which the resilient member 1690 is removably attached. In these embodiments, the removable portion of the body 1636 can be replaced as well if damaged.

As shown, the body 1636 is resiliently mounted to the second end 1626b of the end effector 1626 via coil springs 1692. As shown, the coil springs 1692 are spaced apart from the first and second laser apertures 1638a and 1638b. In this way, such distance can provide as an additional layer of protection from the laser activity generated during operation of the system, which can in turn result in avoiding or preventing damage to the resilient member.

In this embodiment, the body 1636 is disc-shaped and rotatably mounted in a circular opening 1676, e.g. via ball bearings, in a manner to be rotatable around a vertical axis V. Moreover, a motor, such as an air actuator for instance, is provided at the first end 1626a of the end effector 1626, connected to the body 1636 via a pulley 1678. This mechanical arrangement is adapted to allow the robot to rotate the pressing elements 1640a and 1640b in a plane parallel to the busbar in a manner to facilitate the alignment of the pressing elements with corresponding ones of the positive and negative regions of the busbar. As best shown in FIG. 16B, a load cell 1684 is provided along a structural member 1696 extending from the first end 1626a to the second end 1626b of the end effector 1626. The load cell 1684 can provide an indication of the amount of bending stress present in the end effector 1626, as discussed above. In this example, the structural member 1696 is sized and shaped to enhance any mechanical stress imparted at the first or second end of the end effector 1626. More specifically, the structural member 1696 has an elongated thin shape.

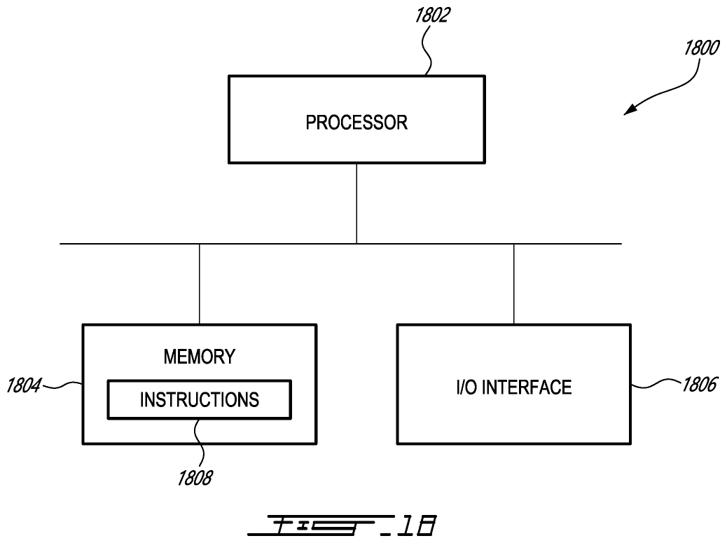

FIG. 17 shows a flow chart of a method 1700 for laser-welding a busbar to a battery module. The method 1700 is described with reference to the system of FIG. 2. Although, it is intended that the method 1700 can be performed by any other suitable system.

At step 1702, the field of view of a laser scanning head is directed towards at least a portion of the busbar. In some embodiments, the laser scanning head can be a Raylase Axial Scan Fiber 30 scanning head.

At step 1704, the end effector is moved within the field of view of the scanning head. As discussed above, the end effector has a resilient member having a first end mounted to the body and a second end opposite the first end, a pressing element at the second end of the resilient member, and a laser aperture extending across the body, the resilient member and the pressing element. The step 1704 includes a step of exposing the pair of positive and negative pole regions of the busbar to the laser scanning head through the laser aperture and a step of forcing one or more pressing element against the busbar and around the positive and negative pole regions of the pair.

At step 1706, during the step of forcing one or more pressing element against the busbar, the method 1700 has a step of activating the laser scanning head to laser weld each of the positive and negative pole regions of the busbar to a respective one of the electrical poles of the battery module through the laser aperture(s) of the end effector.

In some embodiments, the field of view of the scanning head is maintained immobile while the end effector is moved into position relative to the busbar. The scanning head can be moved within a plane parallel to a plane of the busbar in a manner independent from the moving of the end effector. The scanning head can be moved during a welding step, and preferably within periods of time where the laser-welding system is deactivated. The step of moving can include rotating the end effector about an axis normal to a plane of the busbar while maintaining the scanning head immobile. The rotation of the end effector can be dictated by the position and orientation of the pairs of positive and negative pole regions of the busbar, as determined using a camera or according to the design drawing of the battery module, for instance.

Referring now to FIG. 18, the controller of the system of FIG. 2 can be provided as a combination of hardware and software components. The hardware components can be implemented in the form of a computing device 1800, an example of which is described with reference to FIG. 18. The computing device 1800 can have a processor 1802, a memory 1804, and I/O interface 1806. Instructions 1808 for controlling at least the first and second robot arms and laser-welding system can be stored on the memory 904 and accessible by the processor 1802.

The processor 1802 can be, for example, a general-purpose microprocessor or microcontroller, a digital signal processing (DSP) processor, an integrated circuit, a field-programmable gate array (FPGA), a reconfigurable processor, a programmable read-only memory (PROM), a programmable logic controller (PLC), or any combination thereof.

The memory 1804 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1806 enables the computing device 1800 to interconnect with one or more input devices, such as a camera, a pressure sensor, or any other sensor, or with one or more output devices such as robot arm(s), laser-welding system(s). For instance, a pressure sensor or load cell can be mounted to the end effector to measure in real-time the pressure applied by the end effector, or each of its pressing elements, against the busbar.

Each I/O interface 1806 enables the controller to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fibre optics, satellite, mobile, wireless (e.g. Wi-Fi, WiMAX), SS7 signaling network, fixed line, local area network, wide area network, and others, including any combination of these.

The computing device 1800 and any software application that can be ran by the computing device 1800 are meant to be examples only. Other suitable embodiments of the controller can also be provided, as it will be apparent to the skilled reader.

As can be understood, the examples described above and illustrated are intended to be exemplary only. For instance, the system and method described herein can be used to laser weld only one pole region of the busbar per battery cell. Typically, the battery module remains immobile during the welding sequences. As the battery module is heavy, its movement would not be time or resource efficient. The battery module can be moved between laser-welding sequences at least in some embodiments. Although battery cells of cylindrical shapes have been discussed herein, it is intended that the methods and systems described herein can be used to laser-weld busbar(s) to battery cells of any shape or form including, but not limited to, prismatic battery cells. In some embodiments, the end effector is used to force one or more pressing elements against the busbar. However, in some other embodiments, only one pressing element can be forced against the positive pole region of the busbar while only one pressing element can be forced against the negative pole region of the busbar. It is noted that having at least two pressing elements forced against at least one or both of the positive pole region and negative pole region can be preferred. Three pressing elements surrounding the positive pole region or the negative pole region, with the three pressing elements surrounding the corresponding pole region, can be most preferred in some embodiments. In some embodiments, the end effector can have many pairs of first and second laser apertures, each pair exposing the positive and negative pole regions of a corresponding battery cells, with corresponding pressing elements. In these embodiments, the rapidity of the laser-welding sequence can be increased as more than one battery cell can be laser-welded to corresponding pole regions of the busbar during a single laser-welding sequence. The scope is indicated by the appended claims.

What is claimed is:

1. A laser welding system for welding pole regions of a busbar to electrical poles of a stack of battery cells with a laser beam when the busbar and battery cells are received at a welding area with the pole regions located adjacent to and aligned with corresponding ones of the electrical poles, the laser welding system comprising:
a laser welder having an emitter configured to emit the laser beam, and a scanning head optically coupled to the laser emitter;
a robot having an end effector having a body, a resilient member having a first end mounted to the body and a second end opposite the first end, a pressing element at the second end of the resilient member, and a laser aperture extending across the body, the resilient member and the pressing element;
wherein the laser beam is directed across the laser aperture by the scanning head when either one of the pole regions is pressed against a corresponding one of the electrical poles by the pressing element.

2. The laser welding system of claim 1 wherein the resilient member has a helical spring defining a helix around an axis, the pressing element being annular and concentric with the axis of the helical spring.

3. The laser welding system of claim 2 wherein the pressing element is made of a thermally insulating material, is distinct from the helical spring and is mounted to the helical spring.

4. The laser welding system of claim 1 wherein the pressing element is a first pressing element and the laser aperture is a first laser aperture, the end effector further comprising a second pressing element, and a second laser aperture extending across the body and the second pressing element.

5. The laser welding system of claim 4 wherein the resilient member is a first resilient member, further comprising a second resilient member having a first end mounted to the body and a second end opposite the first end, the second pressing element mounted to the second end of the second resilient member, the second laser aperture further extending across the second resilient member.

6. The laser welding system of claim 4 wherein the first pressing element is annular in shape, and the second pressing element has a cashew shaped tip bearing the second laser aperture, the cashew shaped tip positioned adjacent the first pressing element in a plane parallel to the busbar.

7. The laser welding system of claim 6 wherein the second pressing element has a generally planar pressing body having a protuberance leading to the cashew shaped tip, the second pressing element supported by the body via a plurality of helical springs, the helical springs being distributed around the cashew shaped tip in the plane.

8. The laser welding system of claim 4 wherein the first pressing element and the second pressing element are held at different distances from the body when free from the busbar.

9. The laser welding system of claim 4 wherein at least one of the first pressing element and the second pressing element is an electrical insulator.

10. The laser welding system of claim 1 wherein the pressing element is made of an electrically insulating material.

11. The laser welding system of claim 1 wherein the pressing element is made of an electrically conductive material and coated with an electrically insulating material.

12. The laser welding system of claim 1 wherein the body is rotatable around an axis normal to the busbar.

13. The laser welding system of claim 1 wherein the end effector further comprises a collector receptacle extending away from the body, opposite the pressing elements, the collector receptacle fluidly communicating with the laser aperture.

14. The laser welding system of claim 13 further comprising an aspiration conduit having a mouth open to the collector receptacle.

15. The laser welding system of claim 13 further comprising an inert gas conduit leading to the collector receptacle.

16. The laser welding system of claim 1 wherein the end effector has a structural member extending from a first end bearing a robot arm anchor to a second end bearing the body, and a load cell disposed on the structural member.

17. A method for laser-welding a busbar to a battery module, the busbar having at least a pair of pole regions positioned over a corresponding pair of electrical poles of the battery module, the method comprising:
directing a field of view of a laser scanning head towards at least a portion of the busbar;
using a robot arm, moving an end effector within the field of view of the scanning head, the end effector having a body, a resilient member having a first end mounted to the body and a second end opposite the first end, a pressing element at the second end of the resilient member, and a laser aperture extending across the body, the resilient member and the pressing element, said moving including exposing the pair of pole regions of the busbar to the laser scanning head through the laser aperture and forcing the pressing element of the end effector against the busbar and around the pole regions of the pair; and
during said forcing, activating the laser scanning head to laser weld each of the pole regions of the busbar to a respective one of the electrical poles of the battery module through the laser aperture of the end effector.

18. The method of claim 17 further comprising maintaining the field of view of the laser scanning head immobile while the end effector is moved into position relative to the busbar.

19. The method of claim 17 wherein said moving includes moving the scanning head within a plane parallel to a plane of the busbar, the moving of the scanning head being independent from the moving of the end effector.

20. The method of claim 17 wherein said moving the end effector includes rotating the end effector about an axis normal to a plane of the busbar while maintaining the laser scanning head immobile.
